(19) United States
(12) Patent Application Publication
(10) Pub. No.: US 2009/0276440 A1
(43) Pub. Date: Nov. 5, 2009

(54) Embodiments of practical distributed computing

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/387,190

(22) Filed: Apr. 29, 2009

Related U.S. Application Data
(60) Provisional application No. 61/125,815, filed on Apr. 29, 2008.

(51) Int. Cl. G06F 17/30; G06F 15/173; G06F 15/16

(52) U.S. Cl. 707/10; 709/224; 709/227; 707/E17.037; 709/227

(57) ABSTRACT

A practical distributed computing system with almost perfect scalability is realized by distributed has table like search and lookup algorithm implemented in a hardware P2P (peer-to-peer) overlay with multiple P2P software overlays. Each software overlay is implemented as an active database. Each hardware overlay node is any IP device, fixed or mobile; while the system can be implemented with or without a server infrastructure. This system is adapted to multiple applications: multi-player gaming, file sharing within a closed user group, media session handover, event trigger, and behavior-based marketing.

### CROSS REFERENCE TO RELATED APPLICATION

This application claims the benefit of U.S. Provisional Patent Application Ser. No. 61/125,815, filed Apr. 29, 2008, the disclosure of which is herein expressly incorporated by reference.

### FIELD OF THE INVENTION

The present invention relates in general, to distributed networking and computing, and more particularly, to applications and embodiments of practical distributed computing and communication with or without a server infrastructure.

### BACKGROUND OF THE INVENTION

Distributed computing has been the panacea for networking. The main advantage is that under ideal distributed computing, a system will achieve perfect scalability. With perfect scalability, any increment of resources added at any locations will achieve an exact proportional performance increase.

Such systems are often said to have a flat architecture. In a non-flat architecture, resources must be added at bottlenecks in order to gain a proportional performance increase.

In practice, perfect scalability is impossible. The main reason is that it is impossible to satisfy a global information timeliness (GIT) condition. A system is said to possess GIT if all nodes at all time possess timely information regarding the rest of the network. To satisfy a GIT condition, it would require instantaneous (zero propagation delay) communication between all nodes at infinite bandwidth.

Therefore, most nodes must make decisions based on local information; resulting in inefficiency and non-optimality. In particular, bottlenecks will be inevitable. One way to define bottlenecks is that the overall system performance will improve only if resources are added at bottlenecks. Therefore, a system with bottlenecks will not have perfect scalability as any resources added at non-bottlenecks will not add any additional performance.

While it is impossible to achieve ideal distributed computing, it is possible to achieve which might be called “Practical Distributed Computing” or PDC.

The key is that relevant global information from the rest of the system can be retrieved and sent to the nodes that require it in an almost timely manner. This type of timeliness can be called AGIT (almost global information timeliness). If a system satisfies an AGIT condition, it will be called a PDC system.

The reason that AGIT is useful is that in practical systems, global information changes at a finite speed. As long as relevant global information is retrieved and communicated at a speed faster than the speed of global information change, a system will achieves GIT practically. With AGIT, there is no need to pursue GIT or ideal distributed computing.

The new paradigm is to sacrifice some overheads and inefficiency in exchange for AGIT. The overheads may involve communication overheads, delays in getting global information, and the inefficiency may involve intermittent disruptions and non-optimal performance.

There exists a plurality of ways to implement PDC systems. The most popular form is based on DHTs (distributed hash tables). Such systems are often called overlay networks; these two terms will be used interchangeably hereafter. This approach has been canonized by IETF (Internet engineering task force) which has worked to standardize P2P-SIP (peer to peer-session initiation protocol) protocols since October 2007.

In its most basic form, a P2P-SIP system provides a distributed IP directory service. In such a service, a user or device can inquire and obtain a routable IP address of a registered device. Familiar IP directory services include domain name service, VoIP (voice over IP) directory service, and Skype directory service. Most IP directory services are implemented with a centralized server infrastructure as each directory is a DB (database); consistency in a DB is best maintained via centralized servers.

In a DHT-based PDC system, a key component is a directory lookup and retrieval algorithm; famous algorithms from academia include CAN, Chord, Pastry, and Tapestry.

A differentiator of DHT-based directory service is that each node only needs to communicate with only a few other nodes—most commonly, Θ(logn), wherein n is the number of active nodes. In this way, an overall workload can be roughly evenly divided among all overlay nodes. Therefore, it is possible to implement DHT systems without a server infrastructure, centralized or distributed. Such systems are said to be serverless as they use only simple hardware devices; no servers with elaborate resources are required.

A main purpose of the present invention is to enable a broad range of applications of PDC systems through a generic architecture. Specific applications enabled include: multi-player gaming, distributed file sharing, media session handover, event trigger, and behavior-based marketing.

Multi-player gaming refers to electronic gaming with players distributed globally, each with IP connectivity. Distributed file sharing refers to sharing of files between and among users across the globe.

Media session handover is best understood via the example of Skype chat, an IM (instant messaging) service. A common complaint among Skype chat users is that chat messages are not delivered unless both participants are online. This is a fundamental issue for P2P chat services. In a P2P setup, if one end of a communication session is offline, message delivery is suspended. This is not a problem for server-based chat services such as MSN. However, a P2P infrastructure is much cheaper than a server-based infrastructure. The present invention capitalizes on highly scalable and practically zero-cost PDC infrastructures, and enables virtual-real time delivery of chat messages. A message is delivered whenever an intended receiver is online, independent of the online status of the message sender.

In an event trigger service, once a specific condition is satisfied, an event is said to have triggered and a user that set this trigger previously is to be notified—often some actions are to take place automatically. The present invention utilizes a PDC system to store event triggers and to help implement triggering mechanisms. Examples of events include: availability for a merchandize with a specific price range, TV shows, delivery of goods and services, changes in offered prices for a merchandize, etc.

The last application is behavior-based marketing. Marketing in the Internet era relies heavily on tracking online user behaviors, both private and social. The present invention deploys a PDC system to track user behaviors and marketing events. One example is to reward a buyer of video downloads to recommend the same or similar videos to his contacts by giving him discounts or other forms of rewards, once his contacts also purchase the recommended products.

### BRIEF SUMMARY OF THE INVENTION

It is, therefore, an object of the present invention to provide a system and methods to enable PDC systems for a broad range of applications: multi-player gaming, distributed file sharing, media session handover, event trigger, and behavior-based marketing.

A generic architecture of a PDC system is comprised of three components: overlay nodes, a user group, and application software systems comprised mainly of active databases (ADBs), or more generally, DBs.

Applications of this PDC architecture are enabled by mapping specific functions to particular ADBs or traditional databases. An ADB is not restricted to follow an ECA (event-condition-action) model.

For media session handover, a session history ADB is created for each user. The state of a session is periodically updated to the associated session history ADB. Once a session is resumed, a resumed user can retrieve the most updated history from an associated session history ADB.

In an event trigger applications, two ADBs are deployed: one to track user information, and the other to track events. A third module is to implement event trigger, used in conjunction with the two ADBs.

In behavior-based marketing applications, the event trigger architecture is adapted. Both marketers and customers are allowed to set triggers or subscribe to events.

### BRIEF DESCRIPTION OF THE DRAWINGS

The above and other objects and features in accordance with the present invention will become apparent from the following descriptions of embodiments in conjunction with the accompanying drawings, and in which:

FIG. 1 shows the generic architecture of PDC systems;

FIG. 2 displays the logic to resume an interrupted session;

FIG. 3 displays the logic to terminate a media session;

FIG. 4 illustrates the modules in an event-trigger overlay node.

### DETAILED DESCRIPTION OF EXEMPLARY EMBODIMENTS

To construct PDC systems for a broad range of applications, three components are needed: a physical overlay network comprising of hardware devices as individual overlay nodes, a user group, and application software systems hosted on the overlay nodes. In a PDC system, no servers according to sever-client architecture are required; all overlay nodes, or simply nodes, are peers functioning as both servers and clients. Therefore, a PDC system is a pure P2P system with all data plane and control plane functions implemented in a P2P manner.

For security reasons, it might be necessary to build hybrid systems wherein servers are deployed in conjunction with a serverless subsystem. The present invention, however, only deals with the serverless part of such hybrid systems. Therefore, it is hereafter assumed that an entire PDC system is serverless.

The overlay nodes are fixed or mobile devices connected to an IP network. All communications within a PDC system are IP based. A node can be a PC (laptop, palmtop, or desktop), a mobile (smart or feature) phone, PDA (personal digital assistant), a gaming device, a router, a switch, a customer premise equipment piece, a consumer electronic appliance, or any hardware IP device. A user can be contacted via a plurality of media types: VoIP (voice or video over IP), IM (instant messaging, text, or chat), Web browsing, email, and game playing. It is also assumed that a user is uniquely identified by an ID (it is also possible a user may have multiple unique IDs within specific administrative domains), and each device is uniquely identified by its own device ID.

A primary function of PDC systems is to provide directory and connection services. In a directory service, the address (IP or other forms) of an overlay node that contains a needed data item can be retrieved via a key in a distributed database hosted in a PDC system. In a connection service, two devices are connected via communication protocols. The present invention, in addition, expands the basic directory and connection services to a broad range of applications and services.

In accordance with one aspect of the present invention, a PDC system also provides distributed DB services. The entirety of each DB is divided according to a mapping into small sub-DBs. Each sub-DB is to be hosted in an overlay node. The mapping is not restricted except it must divide the entire DB in such a way that the workload at each overlay node is roughly even.

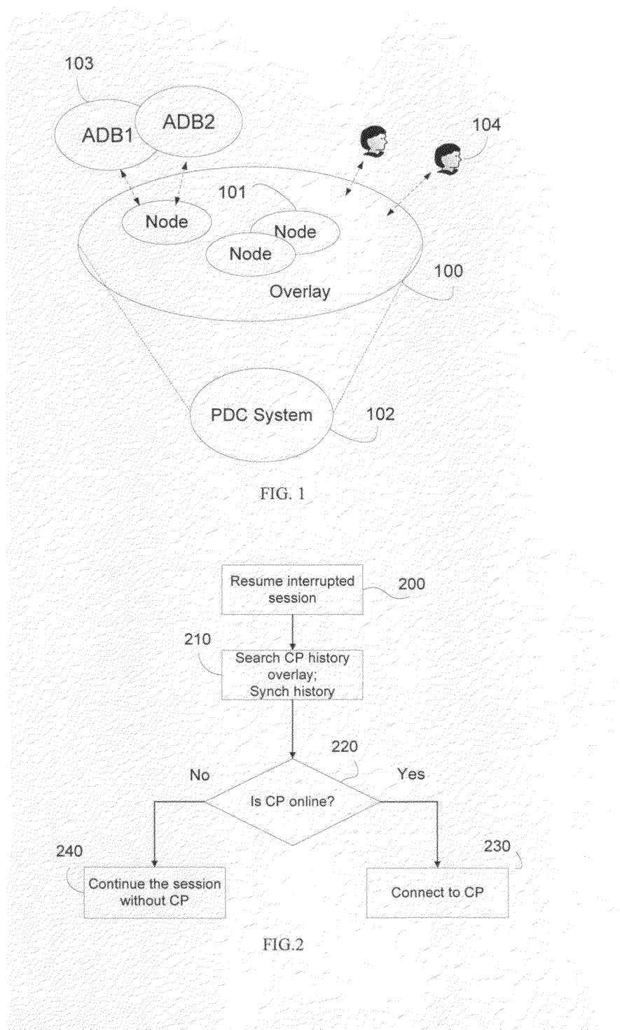

The generic architecture of a PDC system is illustrated in FIG. 1. In this figure, three components are indicated: an overlay 100 of hardware nodes 101, a group of individual users 104, and a plurality of ADBs hosted on individual nodes 101. In FIG. 1, only two ADBs are shown; while in general, the number of ADBs is a design issue. It should be noted that, in accordance with the present invention, an ADB is generic: an ADB can be an active or traditional database whose model might not be ECA. This abstract architecture is called a PDC system 102; its usefulness will be fully appreciated in the description hereafter.

The overlay concept is logical—it is possible to host multiple software overlays on the same or overlapping hardware overlays. Each software overlay is associated with an ADB. Therefore, the two terms—overlay and ADB—will be used interchangeably hereafter.

An immediate application of the PDC system is multi-player gaming. In this application, a player ADB is used to track the online status and IP addresses of a group of game players. Each player can reside at any location with a gaming device; the only requirement is that the device has an IP connection, and the player and the device register with the player ADB.

A slightly more elaborate application is file sharing within a closed user group. In this application, each user allows some of his devices to be open for filing sharing (with agreed upon limitations). A user-device ADB is used to track users and their devices in the closed user group. Each user can reside at any location with a file transfer device; the only requirement is that the device has an IP connection, and the user and the device register with the user-device ADB.

A more elaborate application of the PDC system is P2P media session handover. In this application, a media session can be any of the following: (1) an instant messaging or chat; (2) an audio/video (AV) session; (3) an application session (a specialized session that uses a protocol stack to transmit application information). Notice that a media session can be point-to-point or multipoint-to-multipoint (conference type).

For this application, it is assumed that a media session is interrupted and resumption of an original session is desirable. While it is not common to resume an AV conversation; it is common to resume an IM conversation, or an application session such as online purchase or interactive gaming. When the resumption of an interrupted session is not desirable, the present invention provides a convenient means to store and retrieve historical records of ended conversations or application session. This archiving functionality is deemed to be important in numerous applications in modern life.

In accordance with one embodiment of the present invention, an overlay called directory overlay is deployed to tracks the online status of all users. For each user, an individual overlay called a session history overlay is used to track (store, retrieve, and trim) all the media sessions associated with the user. The directory overlay also provides a directory service to reach individual session history overlays.

A software module, residing in a physical device serving media sessions for a user, automatically forwards the state of media sessions to the session history overlay associated with the user. Forwarding is done either periodically or upon disruption of a media session. Forwarding of the state of a media sessions is implemented if after a disruption, the device is still powered up and a communication channel is available to communicate with the history overlay.

FIG. 2 shows the steps executed for resuming an interrupted session. At step 200, an individual user is ready to resume his interrupted session. At step 210, the user device searches for CP's (corresponding person's) history overlay using the directory overlay. It then retrieves most recent history from the CP's session history overlay. At step 220, the user device uses the directory overlay again to check the online status of the CP. If the CP is online, then a connection request is sent to the CP (step 230); otherwise, the resumed session might continue without the CP being connected (step 240).

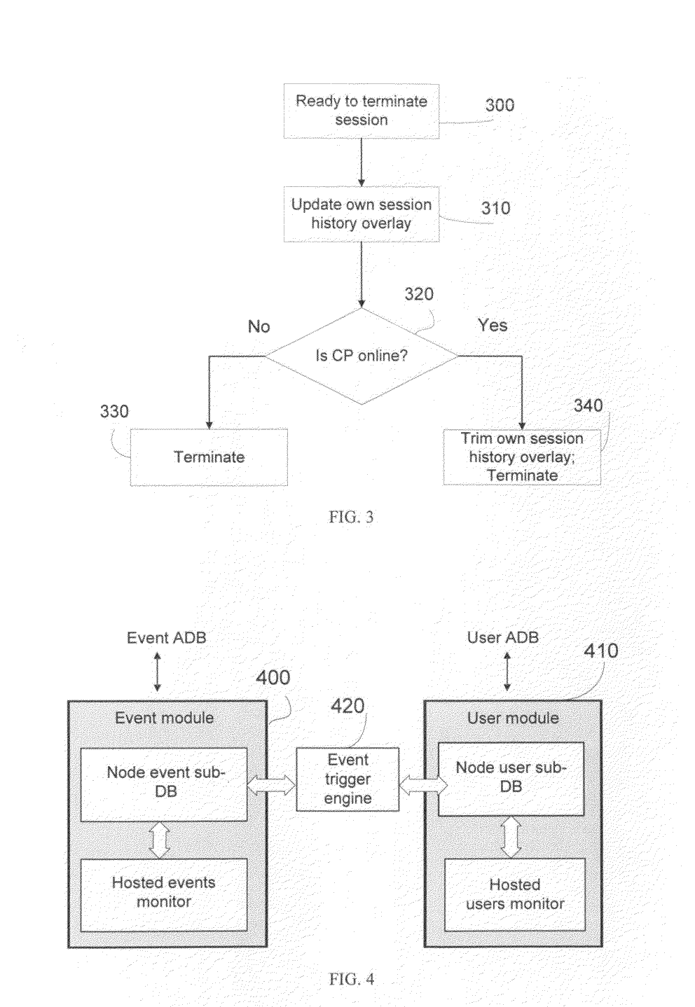

FIG. 3 shows the steps executed for terminating a session. At step 300, the user device is ready to terminate a session; at step 310, the user device updates its own session history overlay with the current state of the session. At step 320, a check is conducted to see if the CP is online using the directory overlay. If the CP is online, then the user might choose to trim its own session history overlay (step 340) or simply to terminate (step 330).

The next application of the PDC system is an event trigger service. In accordance with an embodiment, the software system hosted on an overlay node is comprised of three modules: an event module, an event trigger engine, and a user module. The event modules at different overlay nodes communicate with each other; similarly, the user modules at different overlay nodes communicate with each other. Together with the event trigger engine, the entirety of event modules comprises an event ADB, while the entirety of the user modules comprises a user ADB. The user ADB is a database that hosts all the users subscribed to the underlying event trigger service, while the event ADB is a database that hosts allowable events.

Architecture of the software system hosted in an overlay node for the event trigger service is illustrated in FIG. 4.

The user module 410 is further comprised of two sub-modules: a node user sub-DB and a hosted users monitor module. Each overlay node is to host a small group of local users. The node user sub-DB contains the part of the user ADB that is located within the local node. The hosted user monitor module performs functions related to locally hosted users such as subscriptions to events by users, and actions to take place once an event triggers.

The event module 400 is further comprised of two sub-modules: a node event sub-DB and a hosted event monitor module. The node event sub-DB contains the part of the event ADB located within the local node. Each overlay node is to host a local group of events, in the sense that these events are directly observed or monitored at the node. The hosted event monitor module performs functions related to the locally hosted events such as reporting happenings related to the locally hosted events to the node event sub-DB module.

The event trigger engine 420 is a software module that monitors and performs event triggers; following an ECA model is an option. When and if an event expires without triggering, the subscribed users will be notified; thus, a non-triggered event is a special kind of event trigger.

A next application of the PDC system is behavior-based marketing. In accordance with one aspect of the present invention, this application is actually adapted from an event trigger service.

Specifically, a user can be either a customer or a marketer; an event can be a marketing event or non-marketing event. There will be three ADBs; a customer ADB adapted from the original user module to track customer behaviors, a marketer ADB to track marketing events related to marketers, and an event module to track events allowed in such a service. A node is to host or monitor a local group of customers, marketers, or events.

A noted difference in functionality between event trigger application and behavior-based marketing application exists. In event trigger applications it is a user that takes the initiative to subscribe to an event; however, in behavior-based marketing applications, both a marketer and a customer can take the initiative to create a subscription to a marketing event.

What is claimed is:

1. A system to realize practical distributed computing with almost perfect scalability in peer-to-peer architecture for both control and data planes, comprising:
a plurality of hardware overlay nodes, or nodes, comprising a hardware overlay;
a plurality of users;
a plurality of database systems called ADBs;
a distributed directory search and retrieval algorithm;
wherein each said node is an IP device connected to an IP network; each said ADB comprises a software overlay hosted on said hardware overlay; a said ADB is either an active database or a traditional database, and all data plane and control plane functions of said ADBs are implemented in P2P manner, and each said ADB is subdivided into sub-DBs or sub-databases, with each sub-DB hosted on a said node; said distributed directory search and retrieval algorithm is based on distributed hash tables.

2. The system of claim 1, wherein each overlay node functions as a peer (both server and client), and each said node is a fixed or mobile IP device which can be a computer, a phone device, a personal digital assistant, a gaming device, a switch, a router, a media player, a customer premise equipment piece, a consumer electronic appliance, or a special-purpose hardware device.

3. The system of claim 2, adapted to realize multi-player gaming, wherein a said ADB is used to track online status of a plurality of game players with their associated gaming devices; each said player and said gaming device are to register with said ADB; said ADB is to store a routable IP address to reach a said registered gaming device.

4. The system of claim 2, adapted to file sharing within a closed user group, wherein a said ADB is used to track online status of a plurality of users with their associated file transfer devices; each said user and said file transfer device are to register with said ADB; said ADB is to store a routable IP address to reach a said registered file transfer device.

5. The system of claim 2, adapted to realize an event-trigger service, wherein
an ADB to track said users and their subscriptions to events;
an ADB to track a plurality of allowed events in said service;
an event trigger engine software module at each said node;
a user software module at each said;
an event software module at each said node;
wherein each said node is to host a local group of said users and to monitor a local group of said events; said user module also performs event subscription and event un-subscription related functions for users locally hosted at a said node; said event module also reports happenings related to events monitored locally at a said node; said event trigger engine performs event trigger functions and related actions to take place following an event trigger.

6. The system of claim 5, adapted to realize a behavior-based marketing service, wherein
a user can be either a customer or a marketer;
an event can be either a marketing event or a non-marketing event;
an ADB to track said customers, their behaviors, and their subscriptions to events;
an ADB to track marketers, and their subscriptions to events;
wherein both marketers and customers allowed to subscribe to event triggers.

7. The system of claim 2, adapted to realize a P2P media session handover, wherein
for each said user, an individual session history ADB to track session states and history;
current state of each session is, periodically or upon disruption, updated to an associated history ADB;
an overall user ADB to track all said users and to provide directory service to reach session history ADBs;
wherein upon resumption of a media session, a user device downloads from a session history ADB that contains most updated message or history records of the same session; a media session is of three types: audio/video conversation, text messaging, and application session of all kinds.

8. A computer-readable medium with a computer program for performing the methods as described in any one of claims 1 to 7.
